(19) United States
(12) Patent Application Publication
(10) Pub. No.: US 2020/0021831 A1
(43) Pub. Date: Jan. 16, 2020

(54) IMAGE ENCODING/DECODING METHOD, VIDEO ENCODER/DECODER, AND VIDEO CODING/DECODING SYSTEM

(71) Applicant: HUAWEI TECHNOLOGIES CO., LTD., Shenzhen (CN)

(72) Inventors: Yin Zhao, Hangzhou (CN); Haitao Yang, Shenzhen (CN); Shan Gao, Shenzhen (CN)

(73) Assignee: HUAWEI TECHNOLOGIES CO., LTD., Shenzhen (CN)

(21) Appl. No.: 16/584,141

(22) Filed: Sep. 26, 2019

Related U.S. Application Data
(63) Continuation of application No. PCT/CN2018/080512, filed on Mar. 26, 2018.

(30) Foreign Application Priority Data
Mar. 28, 2017 (CN) 201710192404.9

(51) Int. Cl. H04N 19/44; H04N 19/96; H04N 19/192; G06F 9/30

(52) U.S. Cl. CPC H04N 19/44; G06F 9/30058; H04N 19/192; H04N 19/96

(57) ABSTRACT

This application relates to video coding/decoding technologies, and discloses an image decoding method, a video decoder, an image encoding method, a video encoder, and a video coding/decoding system. The image decoding method includes: obtaining information about a first leaf node obtained by splitting a coding tree unit serving as a root node; when the information about the first leaf node meets a split condition, obtaining split instruction information of the first leaf node; when the split instruction information of the first leaf node is used to instruct to split the first leaf node, obtaining encoding information corresponding to a second leaf node obtained by splitting the first leaf node serving as a root node; and generating, based on the encoding information corresponding to the second leaf node, a reconstructed image corresponding to the second leaf node.

### CROSS-REFERENCE TO RELATED APPLICATIONS

This application is a continuation of International Application No. PCT/CN2018/080512, filed on Mar. 26, 2018, which claims priority to Chinese Patent Application No. 201710192404.9, filed on Mar. 28, 2017. The disclosures of the aforementioned applications are hereby incorporated by reference in their entireties.

### TECHNICAL FIELD

This application relates to the field of video coding/decoding technologies, and in particular, to an image decoding method, a video decoder, an image encoding method, a video encoder, and a video coding/decoding system.

### BACKGROUND

Significance of video coding is to transmit high-quality video data at a bandwidth as low as possible. Various video coding standards such as MPEG-1, MPEG-2, H.263, H.264, H.265, and joint exploration model (joint exploration model, JEM) are proposed to optimize a code stream and improve encoding efficiency.

In the foregoing standards, adaptive quadtree split of an image block is introduced into H.265 based on H.264, thereby greatly improving a compression capability of a flat image region. Based on quadtree split of H.265, binary tree split is added to the JEM, so that a code unit (coding unit, CU) may be a square or a rectangle. Because there are more diversified shapes of code units, content of a local image can be better adapted.

The JEM is used as an example. In an implementation process of this application, the inventor finds that a common technology has at least the following problem: In the JEM, sizes of CUs that may be formed after quadtree leaf nodes of different quadtree levels are split through binary tree split are different, and generally, sizes of CUs formed by quadtree leaf nodes of lower quadtree levels obtained through binary tree split are relatively large; in this case, if images corresponding to CUs with a relatively large size have complex textures, encoding efficiency is relatively low. To resolve this problem, a method of increasing a maximum binary tree level may be used to enable a quadtree leaf node of a lower quadtree level to form a CU with a smaller size through binary tree split. However, this method causes the following two problems: (1) An increase of a maximum binary tree level increases a quantity of types of binary tree split that need to be tried by a video encoder, thereby increasing encoding complexity; and (2) an increase of a maximum binary tree level is accompanied with an increase of split instruction information corresponding to a binary tree node, thereby reducing encoding efficiency. For example, when the maximum binary tree level is 3, a node whose binary tree level is 3 cannot be split by default. In this case, a bit (that is, split instruction information) indicating whether to split the node does not need to be added to the code stream. When a maximum binary tree level is increased to 4, a node whose binary tree level is 3 may be further split into a node whose binary tree level is 4. In this case, a bit indicating whether the node is to be further split needs to be added to the code stream. Consequently, encoding efficiency of the node whose binary tree level is 3 is reduced.

In conclusion, a common technology cannot achieve a balance between encoding complexity and encoding efficiency.

### SUMMARY

This specification describes an image decoding method, a video decoder, an image encoding method, a video encoder, and a video coding/decoding system, to achieve a balance between encoding complexity and encoding efficiency.

According to one aspect, an embodiment of this application provides an image decoding method. After obtaining a code stream corresponding to a coding tree unit (coding tree unit, CTU), a video decoder first obtains information about a first leaf node (for example, a binary tree leaf node or a ternary tree leaf node) obtained by splitting the CTU serving as a root node; then determines whether the information about the first leaf node meets a preset split condition; when the information about the first leaf node meets the split condition, obtains split instruction information of the first leaf node from the code stream; and when the split instruction information of the first leaf node is used to instruct to split the first leaf node, obtains encoding information corresponding to a second leaf node obtained by splitting the first leaf node serving as a root node. Subsequently, the video decoder generates, based on the encoding information corresponding to the second leaf node, a reconstructed image corresponding to the second leaf node, so as to obtain a reconstructed image corresponding to the coding tree unit. According to the image decoding method provided in this embodiment of this application, a CU with a relatively large size may be further split without changing a limitation of an original maximum split level. Therefore, this can achieve a balance between encoding efficiency and encoding complexity.

The first leaf node is a leaf node obtained by splitting the CTU by using a common technology, and may also be referred to as a first-level leaf node or a first-type leaf node, for example, a leaf node obtained through QTBT split in the JEM. The second leaf node is a leaf node obtained by further splitting the first leaf node serving as the root node, and may also be referred to as a second-level leaf node or a second-type leaf node.

The information about the first leaf node may include image-related data such as a width, a height, and coordinates of an image corresponding to the first leaf node, and may further include split level information of the first leaf node. For example, the split level information of the first leaf node obtained by splitting the CTU in a QTBT split manner in the JEM includes quadtree split level information (that is, a quadtree level of the node) and/or binary tree split level information (that is, a binary tree level of the node).

In a possible design, the first leaf node is a binary tree leaf node obtained by splitting the CTU serving as the root node in a binary tree manner or in a manner of cascading a quadtree and a binary tree; and the second leaf node is a quadtree leaf node obtained by splitting the first leaf node serving as the root node in a quadtree manner.

An example in which the first leaf node is a leaf node obtained by splitting the CTU in a binary tree manner or in a manner of cascading a quadtree and a binary tree is used. According to the image decoding method provided in this embodiment of this application, a CU with a relatively large size may be further split without changing a maximum binary tree split level. When the binary tree leaf node meets the preset split condition, node split instruction information of the binary tree leaf node is obtained. When the split instruction information of the binary tree leaf node is used to instruct to split the binary tree leaf node, the binary tree leaf node is further split to form a quadtree leaf node with a relatively small size. In this processing manner, encoding efficiency can be improved, and encoding complexity is not greatly affected. Therefore, this can achieve a balance between the encoding efficiency and the encoding complexity.

In a possible design, if the first leaf node is a binary tree leaf node, the preset split condition includes but is not limited to at least one of the following conditions: The image corresponding to the first leaf node is of a square shape; the binary tree level of the first leaf node is greater than or equal to a first preset threshold; and a side length of the image corresponding to the first leaf node or a logarithm of the side length to base 2 is greater than a second preset threshold. The preset split condition may be any one of the foregoing conditions, or may be any combination of the foregoing conditions.

Additional quadtree split is performed on a square binary tree leaf node due to the following reason: Based on statistical data, under a split policy based on rate-distortion optimization, a probability that a non-square node is split into four non-square nodes is lower than a probability that a square node is split into four square nodes, and efficiency of performing quadtree split on a non-square node is not greatly improved. Therefore, quadtree split can still be performed on the square binary tree leaf node in this embodiment of this application. In this processing manner, only encoding complexity is slightly increased, and encoding efficiency of the square binary tree leaf node is improved.

The first preset threshold may be set in the video decoder (for example, set to a constant such as 2 or 4), or may be obtained by parsing the code stream. It is set that the split condition is that the binary tree level of the first leaf node is greater than or equal to the first preset threshold, so that only a first leaf node whose binary tree level is greater than or equal to the first preset threshold is allowed to be further split. In this processing manner, a quantity of first leaf nodes that can be further split can be controlled. Therefore, only encoding complexity may be slightly increased, and encoding efficiency of the square binary tree leaf node is improved.

The second preset threshold may be set in the video decoder (for example, set to a constant or a minimum CU side length), or may be obtained by parsing the code stream. It is set that the split condition is that the side length of the image corresponding to the first leaf node or the logarithm of the side length to base 2 is greater than the second preset threshold, so that only a first leaf node whose side length of a corresponding image or logarithm of the side length to base 2 is greater than the second preset threshold is allowed to be further split. In this processing manner, a CU of a very small size can be effectively prevented from being obtained through split.

Certainly, it can be understood that, when the first leaf node is a binary tree leaf node, the video decoder may split the binary tree leaf node in a ternary tree manner or the like, or may further split a non-square binary tree leaf node, so as to reduce a CU size. When the first leaf node is a ternary tree leaf node, the ternary tree leaf node may be split in a binary tree manner, a quadtree manner, or the like; or when the first leaf node is a quadtree leaf node, the quadtree leaf node may be split in a binary tree manner, a ternary tree manner, or the like.

In a possible design, when the split instruction information of the first leaf node is used to instruct not to split the first leaf node, or when the information about the first leaf node does not meet the preset split condition, the first leaf node is a CU. In this case, the video decoder obtains encoding information corresponding to the first leaf node, and generates, based on the encoding information corresponding to the first leaf node, a reconstructed image corresponding to the first leaf node.

In a possible design, the video decoder obtains the encoding information corresponding to the second leaf node obtained by performing one-layer split on the first leaf node. In this processing manner, one-layer split is performed on only the first leaf node, and a subnode of the first leaf node obtained by splitting the first leaf node serves as the CU. Therefore, only encoding complexity is slightly increased, and encoding efficiency of a binary tree leaf node is improved.

In a possible design, the video decoder obtains the encoding information corresponding to the second leaf node obtained by performing at-least-two-layer split on the first leaf node. In this processing manner, at-least-two-layer split may be performed on the first leaf node, and a subnode of the first leaf node is allowed to be further split into a plurality of smaller CUs. Therefore, encoding efficiency can be further improved in a region having a complex texture.

In a possible design, when the video decoder allows to perform at-least-two-layer split on the first leaf node, the following steps may be performed to obtain the encoding information corresponding to the second leaf node: obtaining split instruction information of a current node obtained by performing one-layer split on the first leaf node; and when the split instruction information of the current node is used to instruct to split the current node, obtaining the encoding information corresponding to the second leaf node obtained by splitting the current node. In a process of splitting the first leaf node, for a subnode on each layer of the first leaf node, when split instruction information of the subnode is used to instruct to split the subnode, the subnode may be further split, until the encoding information corresponding to the second leaf node is obtained.

In a possible design, when information about the current node obtained by performing one-layer split on the first leaf node meets a preset recursive split condition, the video decoder obtains the split instruction information of the current node. In a process of splitting the first leaf node, for a subnode on each layer of the first leaf node, split instruction information of the subnode may be obtained when information about the subnode meets the recursive split condition.

In a possible design, the preset recursive split condition includes but is not limited to at least one of the following conditions: A recursive split level of the current node is less than a third preset threshold; and a side length of an image corresponding to the current node or a logarithm of the side length to base 2 is greater than a fourth preset threshold. The preset recursive split condition may be either of the foregoing conditions, or may be any combination of the foregoing conditions.

The third preset threshold may be set in the video decoder (for example, set to a constant such as 2), or may be obtained by parsing the code stream. It is set that the recursive split condition is that the recursive split level of the current node is less than the third preset threshold, so that only a current node whose recursive split level is less than the third preset threshold is allowed to be further split. In this processing manner, only encoding complexity is slightly increased, and encoding efficiency is improved.

The fourth preset threshold may be set in the video decoder (for example, set to a constant or a minimum CU side length), or may be obtained by parsing the code stream. It is set that the split condition is that the side length of the image corresponding to the current node or the logarithm of the side length to base 2 is greater than the fourth preset threshold, so that only a current node whose side length of a corresponding image is greater than the fourth preset threshold is allowed to be further split. In this processing manner, a CU of a very small size can be effectively prevented from being obtained through split.

According to another aspect, an embodiment of this application provides a video decoder, and the video decoder includes a corresponding module configured to perform behavior of the video decoder in the foregoing image decoding method design. The module may be software and/or hardware.

In a possible design, the video decoder includes a processor and a memory. The processor is configured to support the video decoder in performing a corresponding function in the foregoing image decoding method. The memory is configured to couple to the processor, and the memory stores a program instruction and data that are necessary for the video decoder.

In a possible design, the video decoder includes: a first leaf node information obtaining unit, configured to obtain information about a first leaf node obtained by splitting a coding tree unit serving as a root node; a split instruction information obtaining unit, configured to: when the information about the first leaf node meets a split condition, obtain split instruction information of the first leaf node; an encoding information obtaining unit, configured to: when the split instruction information of the first leaf node is used to instruct to split the first leaf node, obtain encoding information corresponding to a second leaf node obtained by splitting the first leaf node serving as a root node; and a reconstructed image generation unit, configured to generate, based on the encoding information corresponding to the second leaf node, a reconstructed image corresponding to the second leaf node.

According to still another aspect, an embodiment of this application provides an image encoding method. A video encoder first splits a CTU of a to-be-encoded image serving as a root node, to obtain a first leaf node; then determines whether information about the first leaf node meets a preset split condition; when the information about the first leaf node meets the split condition, determines whether to split the first leaf node; and when determining to split the first leaf node, splits the first leaf node serving as a root node, to obtain a second leaf node. Subsequently, the video encoder generates, based on image data of the second leaf node, a code stream corresponding to the CTU. The code stream corresponding to the CTU includes encoding information corresponding to the second leaf node and split instruction information of the first leaf node, and the split instruction information of the first leaf node is used to instruct to split the first leaf node.

An example in which the first leaf node is a leaf node obtained by splitting the CTU in a binary tree manner or in a manner of cascading a quadtree and a binary tree is used. According to the image encoding method provided in this embodiment of this application, an image with a relatively large size may be further split without changing a maximum binary tree split level. When a binary tree leaf node meets the preset split condition, the binary tree leaf node is further split to form an image with a relatively small size. In this processing manner, encoding efficiency of some binary tree leaf nodes can be improved, and encoding complexity is not greatly affected. Therefore, this can achieve a balance between the encoding efficiency and the encoding complexity.

In a possible design, the preset split condition includes at least one of the following conditions: An image corresponding to the first leaf node is of a square shape; a binary tree level of the first leaf node is greater than or equal to a first preset threshold; and a side length of the image corresponding to the first leaf node or a logarithm of the side length to base 2 is greater than a second preset threshold.

In a possible design, the second leaf node is a leaf node obtained by splitting the first leaf node serving as the root node in a quadtree manner.

In a possible design, when it is determined that the first leaf node is not to be split, the code stream corresponding to the CTU is generated based on image data of the first leaf node. The code stream corresponding to the CTU includes encoding information corresponding to the first leaf node and the split instruction information of the first node, and the split instruction information of the first leaf node is used to instruct not to split the first leaf node.

In a possible design, when the information about the first leaf node does not meet the preset split condition, the code stream corresponding to the CTU is generated based on image data of the first leaf node. The code stream corresponding to the CTU includes encoding information corresponding to the first leaf node.

In a possible design, the video encoder may perform one-layer split on the first leaf node to obtain the second leaf node, or may perform at-least-two-layer split on the first leaf node to obtain the second leaf node.

In a possible design, when the video encoder allows to perform at-least-two-layer split on the first leaf node, the following steps may be performed to split the first leaf node to obtain the second leaf node: performing one-layer split on the first leaf node to obtain a current node; determining whether to split the current node; and when it is determined to split the current node, splitting the current node to obtain the second leaf node.

In a possible design, when information about the current node obtained by performing one-layer split on the first leaf node meets a recursive split condition, it is determined to split whether the current node.

In a possible design, the preset recursive split condition includes but is not limited to at least one of the following conditions: A recursive split level of the current node is less than a third preset threshold; and a side length of an image corresponding to the current node or a logarithm of the side length to base 2 is greater than a fourth preset threshold. The preset recursive split condition may be either of the foregoing conditions, or may be any combination of the foregoing conditions.

In a possible design, the following steps may be performed to determine whether to split the first leaf node: obtaining a first rate-distortion cost generated before the first leaf node is split; obtaining a second rate-distortion cost generated after the first leaf node is split; and if the first rate-distortion cost is less than or equal to the second rate-distortion cost, determining to split the first leaf node; otherwise, determining not to split the first leaf node.

According to still another aspect, an embodiment of this application provides a video encoder, and the video encoder includes a corresponding module configured to perform behavior of the video encoder in the foregoing image encoding method design. The module may be software and/or hardware.

In a possible design, the video encoder includes a processor and a memory. The processor is configured to support the video encoder in performing a corresponding function in the foregoing image encoding method. The memory is configured to couple to the processor, and the memory stores a program instruction and data that are necessary for the video encoder.

In a possible design, the video encoder includes a first split unit, configured to split a coding tree unit serving as a root node, to obtain a first leaf node; a second split determining unit, configured to: when information about the first leaf node meets a split condition, determine whether to split the first leaf node; a second split unit, configured to: when it is determined to split the first leaf node, split the first leaf node serving as a root node, to obtain a second leaf node; and a code stream generation unit, configured to generate, based on image data of the second leaf node, a code stream corresponding to the CTU, where the code stream corresponding to the CTU includes encoding information corresponding to the second leaf node and split instruction information of the first leaf node, and the split instruction information of the first leaf node is used to instruct to split the first leaf node.

According to still another aspect, an embodiment of this application provides a video coding/decoding system, and the system includes the video encoder and the video decoder in the foregoing aspects.

According to yet another aspect, an embodiment of this application provides a computer readable storage medium. The computer readable storage medium stores an instruction, and when the instruction is run on a computer, the computer is enabled to perform the methods in the foregoing aspects.

According to yet another aspect, an embodiment of this application provides a computer program product including an instruction, and when the computer program product is run on a computer, the computer is enabled to perform the methods in the foregoing aspects.

Compared with a common technology, the solutions provided in this application achieve a balance between encoding efficiency and encoding complexity.

### BRIEF DESCRIPTION OF DRAWINGS

FIG. 1 is a schematic structural diagram of a video coding/decoding system according to an embodiment of this application;

FIG. 2 is a schematic diagram of a CTU split manner according to an embodiment of this application;

FIG. 3 is a schematic flowchart of an image decoding method according to an embodiment of this application;

FIG. 4 is a schematic flowchart of searching for a first leaf node in an image decoding method according to an embodiment of this application;

FIG. 5 is another flowchart of searching for a first leaf node in an image decoding method according to an embodiment of this application;

FIG. 6 is a schematic flowchart of step 304 in an image decoding method according to an embodiment of this application;

FIG. 7 is a specific schematic flowchart of an image decoding method according to an embodiment of this application;

FIG. 8 is a schematic structural diagram of a video decoder according to an embodiment of this application;

FIG. 9 is a schematic flowchart of an image encoding method according to an embodiment of this application; and

FIG. 10 is a schematic structural diagram of a video encoder according to an embodiment of this application.

### DESCRIPTION OF EMBODIMENTS

The following describes an application scenario and technical solutions in the embodiments of this application with reference to the accompanying drawings.

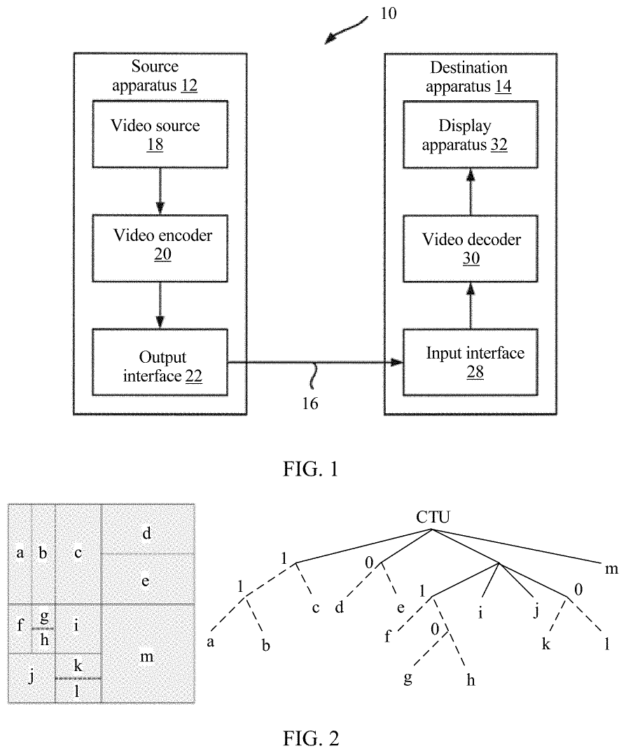

FIG. 1 is a schematic block diagram of a video coding/decoding system 10 according to an embodiment of this application. As shown in FIG. 1, the video coding/decoding system 10 includes a source apparatus 12 and a destination apparatus 14. The source apparatus 12 generates encoded video data. Therefore, the source apparatus 12 may be referred to as a video encoding apparatus or a video encoding device. The destination apparatus 14 may decode the encoded video data generated by the source apparatus 12. Therefore, the destination apparatus 14 may be referred to as a video decoding apparatus or a video decoding device. The source apparatus 12 and the destination apparatus 14 may be examples of a video coding/decoding apparatus or a video coding/decoding device. The source apparatus 12 and the destination apparatus 14 may include a wide range of apparatuses, including a desktop computer, a mobile computing apparatus, a notebook computer (for example, a laptop computer), a tablet computer, a set top box, a handheld computer such as a smartphone, a television, a camera, a display apparatus, a digital media player, a video game console, an in-vehicle computer, or the like.

The destination apparatus 14 may receive the encoded video data from the source apparatus 12 through a channel 16. The channel 16 may include one or more media and/or apparatuses capable of moving the encoded video data from the source apparatus 12 to the destination apparatus 14. In an example, the channel 16 may include one or more communications media that enable the source apparatus 12 to directly transmit the encoded video data to the destination apparatus 14 in real time. In this example, the source apparatus 12 may modulate the encoded video data according to a communication standard (for example, a wireless communication protocol), and may transmit modulated video data to the destination apparatus 14. The one or more communications media may include wireless and/or wired communications media, for example, a radio frequency (RF) spectrum or one or more physical transmission lines. The one or more communications media may form a part of a packet-based network (such as a local area network, a wide area network, or a global network (for example, the Internet)). The one or more communications media may include a router, a switch, a base station, or another device that boosts communication between the source apparatus 12 and the destination apparatus 14.

In another example, the channel 16 may include a storage medium that stores the encoded video data generated by the source apparatus 12. In this example, the destination apparatus 14 may access the storage medium through disk access or card access. The storage medium may include a plurality of locally accessible data storage media such as a Blu-ray, a DVD, a CD-ROM, a flash memory, or another appropriate digital storage medium configured to store encoded video data.

In another example, the channel 16 may include a file server or another intermediate storage apparatus that stores the encoded video data generated by the source apparatus 12. In this example, the destination apparatus 14 may access, through streaming transmission or downloading, the encoded video data stored in the file server or the another intermediate storage apparatus. The file server may be a type of a server capable of storing the encoded video data and transmitting the encoded video data to the destination apparatus 14. The file server in the example includes a web server (for example, used for a website), a file transfer protocol (FTP) server, a network attached storage (NAS) apparatus, and a local disk drive.

The destination apparatus 14 may access the encoded video data through a standard data connection (for example, an Internet connection). Example types of the data connection include a wireless channel (for example, a Wi-Fi connection) and a wired connection (for example, a DSL or a cable modem) that are suitable for accessing the encoded video data stored in the file server, or a combination thereof. The encoded video data may be transmitted by the file server through streaming transmission, download transmission, or a combination thereof.

The technology of this application is not limited to a wireless application scenario. For example, the technology may be applied to video coding/decoding in a plurality of multimedia applications that support the following applications: over-the-air television broadcast, wired television transmission, satellite television transmission, streaming video transmission (for example, through the Internet), encoding of video data stored in a data storage medium, decoding of video data stored in a data storage medium, or another application. In some examples, the video coding/decoding system 10 may be configured to support unidirectional or bidirectional video transmission, to support applications such as streaming video transmission, video play, video broadcast, and/or a video call.

In the example in FIG. 1, the source apparatus 12 includes a video source 18, a video encoder 20, and an output interface 22. In some examples, the output interface 22 may include a modulator/demodulator (a modem) and/or a transmitter. The video source 18 may include a video capture apparatus (for example, a video camera), a video archive including previously captured video data, a video input interface configured to receive video data from a video content provider, and/or a computer graphics system configured to generate video data, or a combination of the foregoing video data sources.

The video encoder 20 may encode video data from the video source 18. In some examples, the source apparatus 12 directly transmits the encoded video data to the destination apparatus 14 by using the output interface 22. The encoded video data may be alternatively stored in the storage medium or the file server, so that the destination apparatus 14 subsequently accesses the encoded video data for decoding and/or playing.

In the example in FIG. 1, the destination apparatus 14 includes an input interface 28, a video decoder 30, and a display apparatus 32. In some examples, the input interface 28 includes a receiver and/or a modem. The input interface 28 may receive the encoded video data through the channel 16. The display apparatus 32 may be integrated with the destination apparatus 14 or may be outside the destination apparatus 14. The display apparatus 32 usually displays decoded video data. The display apparatus 32 may include a plurality of types of display apparatuses, such as a liquid crystal display (LCD), a plasma display, an organic light-emitting diode (OLED) display, or a display apparatus of another type.

The video encoder 20 and the video decoder 30 may perform operations according to a video compression standard (for example, the high efficiency video coding/decoding H.265 standard), and may conform to an HEVC test model (HM). The text description ITU-TH.265 (V3) (04/2015) of the H.265 standard is released on Apr. 29, 2015, and may be downloaded from http://handle.itu.int/11.1002/1000/12455. All content of the document is incorporated by reference in its entirety.

Alternatively, the video encoder 20 and the video decoder 30 may perform operations according to other proprietary or industry standards. The standards include ITU-TH.261, ISO/IECMPEG-1Visual, ITU-TH.262 or ISO/IECMPEG-2Visual, ITU-TH.263, ISO/IECMPEG-4Visual, and ITU-TH.264 (also referred to as ISO/IECMPEG-4AVC), and the standard includes a scalable video coding (SVC) extension and a multiview video coding (MVC) extension. It should be understood that the technology of this application is not limited to any specific coding/decoding standard or technology.

In addition, FIG. 1 is merely an example, and the technology of this application may be applied to a video coding/decoding application (for example, single-side video coding or single-side video decoding) that does not necessarily include any data communication between an encoding apparatus and a decoding apparatus. In another example, data is retrieved from a local memory, and the data is transmitted through network streaming transmission, or the data is operated in a similar manner. The encoding apparatus may encode data and store the data in the memory, and/or the decoding apparatus may retrieve data from the memory and decode the data. In many examples, a plurality of apparatuses that do not communicate with each other and that only encode data into the memory, and/or that only retrieve data from the memory and decode the data perform encoding and decoding.

The video encoder 20 and the video decoder 30 each may be implemented as any one of a plurality of appropriate circuits, for example, one or more microprocessors, a digital signal processor (DSP), an application-specific integrated circuit (ASIC), a field programmable gate array (FPGA), discrete logic, hardware, or any combination thereof. If the technology is partially or completely implemented by using software, the apparatus may store an instruction of the software in an appropriate non-transitory computer readable storage medium, and one or more processors may be configured to execute an instruction in hardware to execute the technology of this application. Any one of the foregoing items (including hardware, software, a combination of hardware and software, and the like) may be considered as one or more processors. The video encoder 20 and the video decoder 30 each may be included in one or more encoders or decoders, and each may be integrated as a part of a combined encoder/decoder (codec (CODEC)) of another apparatus.

This application may generally indicate that specific information is “signaled” by the video encoder 20 to another apparatus (for example, the video decoder 30). The term “signaled” may generally indicate a syntactic element and/or represent transfer of encoded video data. The transfer may occur in real time or approximately in real time. Alternatively, the communication may occur over a time span, for example, may occur when the syntactic element is stored, during encoding, in a computer readable storage medium by using binary data obtained after encoding. The decoding apparatus may retrieve the syntactic element at any time after the syntactic element is stored in the medium.

The foregoing describes an application scenario of this application. To facilitate understanding of the technical solutions of this application, the following briefly describes related concepts and technologies in this application.

In a video coding phase, after one image frame is encoded by using the video encoder 20, the image includes a plurality of CTUs. One CTU usually corresponds to one square image region, and may include luminance pixels and chrominance pixels in the image region, or may include only luminance pixels, or may include only chrominance pixels. In addition, the CTU further includes a syntactic element. The syntactic element indicates how to split the CTU into at least one CU, and the syntactic element may further indicate a method for decoding each CU to obtain a reconstructed image.

The CU usually corresponds to an A×B rectangular region, and includes A×B luminance pixels and corresponding chrominance pixels, where A is a width of the rectangle, B is a height of the rectangle, A and B may be the same or may be different, and values of A and B are usually 2 raised to the power of an integer, for example, 256, 128, 64, 32, 16, 8, or 4. Decoding processing may be performed on one CU to obtain a reconstructed image of one A×B rectangular region, where the decoding processing usually includes prediction, dequantization, inverse transformation, and the like. A predicted image and a residual are generated, and the predicted image and the residual are superposed to obtain the reconstructed image.

The following briefly describes a CTU split technology by using the H.265 video coding standard as an example.

In the H.265 standard, one image frame is segmented into non-overlapping CTUs, and a size of the CTU may be set to 64×64. The 64×64 CTU is a rectangular pixel array including 64 columns, and each column includes 64 pixels. Certainly, the size of the CTU may be alternatively set to another value. For example, in the joint exploration team on future video coding (Joint Exploration team on Future Video Coding, JVET) reference software JEM, the size of the CTU may be set to 128×128 or 256×256.

In the H.265 standard, a quadtree (quad-tree, QT) based CTU split method is used: A CTU serves as a quadtree root node, and the CTU is recursively split into several leaf nodes in a quadtree split manner. One node corresponds to one image region, and if the node is not to be split, the node is referred to as a leaf node. An image region corresponding to the leaf node forms a CU. If the node is further split, the image region corresponding to the node is split into four regions of a same size (a length and a width of each of the four regions are a half of a length and a width of the split region), each region corresponds to one node, and whether these nodes are to be further split needs to be separately determined. Whether to split a node is indicated by a split flag bit (such as split_cu_flag) corresponding to the node in a code stream. A quadtree level (QT level for short) of the root node is 0, and a QT level of a subnode is obtained by increasing a QT level of a parent node by 1. In a quadtree structure, the CTU may be split into a group of CUs of appropriate sizes based on a local image feature. For example, a flat region is split into relatively large CUs, and a richly textured region is split into relatively small CUs. For ease of description, in this application, a size and a shape of an image region corresponding to a node are referred to as a size and a shape of the node.

For example, based on split_cu_flag corresponding to a 64×64 CTU node (a quadtree level is 0), the node may not be split, to form one 64×64 CU, or may be split into four 32×32 nodes (a quadtree level is 1). Each of the four 32×32 nodes may be further split or not split based on split_cu_flag corresponding to the node. If a 32×32 node is further split, four 16×16 nodes are generated (a quadtree level is 2), and so on, until all nodes are not to be further split. In this way, one CTU is split into a group of CUs. A minimum CU size is identified in a sequence parameter set (sequence parameter set, SPS), for example, 8×8 is a minimum CU. In the foregoing recursive split process, if a size of a node is equal to the minimum CU size, the node is not to be further split by default, and a split flag bit of the node does not need to be included in a code stream.

After it is learned, through parsing, that a node is a leaf node, the leaf node is a CU; then encoding information (including information about the CU such as a prediction mode and a transform coefficient, for example, a syntax structure coding_unit( ) in H.265) corresponding to the CU is obtained through parsing; and then decoding processing such as prediction, dequantization, inverse transformation, or loop filtering is performed on the CU based on the encoding information, to generate a reconstructed image corresponding to the CU.

A manner of splitting a CTU into a group of CUs corresponds to a split tree. A split tree that needs to be used for the CTU is usually determined by using a rate-distortion optimization (rate distortion optimization, RDO for short) technology of the video encoder. The video encoder tries a plurality of CTU split manners, and each split manner corresponds to one rate-distortion cost (RD cost). The encoder compares rate-distortion costs of various used split manners to find a split manner with a minimum rate-distortion cost, and the split manner with a minimum rate-distortion cost is used as an optimal CTU split manner for actual encoding of the CTU. The various CTU split manners used by the encoder all need to conform to a split rule specified by the video decoder, so that the CTU split manner can be correctly identified by the decoder.

In this embodiment of this application, the JVET reference software JEM is used as an example for description. Therefore, the following briefly describes a CTU split technology in the JEM.

A binary tree (binary tree, BT) based encoding split manner is added to the JEM. In other words, one node may be further split into two nodes in a binary tree manner. There are two specific binary tree split manners:

(1) “Horizontal split”: A region corresponding to a node is split into two regions (one upper region and one lower region) of a same size (to be specific, widths remain unchanged, and heights are a half of a height of the region before split), and each region corresponds to one node.

(2) “Vertical split”: A region corresponding to a node is split into two regions (one left region and one right region) of a same size (to be specific, heights remain unchanged, and widths are a half of a width of the region before split).

Similar to a quadtree, on a binary tree, a level of a node is referred to as a binary tree level (BT level for short). A BT level of a subnode obtained through binary tree split is obtained by increasing a BT level of a parent node of the subnode by 1. If a BT level of a node is equal to a maximum BT level, the node is not to be further split by default. The maximum BT level may be identified in the SPS.

In actual application, a binary tree and a quadtree may be cascaded, namely, a QTBT split manner. For example, as shown in FIG. 2, the CTU is first split in a QT manner, and a QT leaf node is allowed to be further split in a BT manner. In a right diagram of FIG. 2, each endpoint represents one node, four solid lines connected to one node represent quadtree split, two dashed lines connected to one node represent binary tree split, a to m are 13 leaf nodes, and each leaf node corresponds to one CU. On a binary tree node, 1 represents vertical split, and 0 represents horizontal split. As shown in a left diagram in FIG. 2, one CTU is split into the 13 CUs from a to m based on split in the right diagram. In the QTBT split manner, each CU has a QT level and a BT level, where the QT level represents a QT level of a QT leaf node CU of the CU, and the BT level represents a BT level of a BT leaf node of the CU. In FIG. 2, a QT level and a BT level of a and b are respectively 1 and 2; a QT level and a BT level of c, d, and e are both 1; a QT level and a BT level of f, k, and l are respectively 2 and 1; a QT level and a BT level of i and j are respectively 2 and 0; a QT level and a BT level of g and h are both 2; and a QT level and a BT level of m are respectively 1 and 0. If the CTU is split into only one CU, a QT level of the CU is 0, and a BT level is 0.

The BT split is introduced based on the QT split, and an advantage of this manner is: There are more diversified CU shapes, so that content of a local image is better adapted. In the H.265 standard, all CUs obtained based on the QT split can only be squares. To be specific, a width of the CU is equal to a height. The width of the CU is a quantity of columns of pixels included in the CU, and the height of the CU is a quantity of rows of pixels included in the CU. After the BT split is introduced, a width and a height of the CU may be different. For example, a ratio of the width to the height is 2, 4, 8, 16, ½, ¼, ⅛, or 1/16. In the QTBT split manner, widths and heights of each CU cannot be less than a minimum CU side length.

It should be noted that, if JEM 4.0 is used for video coding, independent QTBT trees are respectively used for luminance pixels and chrominance pixels of a CTU in an I frame (that is, a key frame), a maximum BT level of a QTBT tree of the luminance pixels of the I frame may be represented by a parameter MaxBTDepthISliceL, and a maximum BT level of a QTBT tree of the chrominance pixels of the I frame may be represented by a parameter MaxBTDepthlSliceC; and a same QTBT tree is used for luminance pixels and chrominance pixels of a CTU in a non-I frame, and a maximum BT level may be represented by a MaxBTDepth parameter. The foregoing three maximum BT depth levels all may be identified in the SPS. In this manner, all luminance CUs in the I frame have a same maximum BT level, and all chrominance CUs have a same maximum BT level; and all CUs in the non-I frame have a same maximum BT level.

To facilitate understanding of a problem with a common technology, the following briefly describes a cause of the problem. When the QTBT split manner is used, quadtree leaf nodes of different QT levels may be split into different minimum CUs through split. For example, when a size of the CTU is set to 64×64 and a maximum BT level is set to 3, a minimum CU that may be obtained by performing BT split on a quadtree leaf node (a size is 64×64) whose QT level is 0 includes 512 pixels (for example, 32×16, 16×32, 8×64, or 64×8); a minimum CU that may be obtained by performing BT split on a quadtree leaf node (a size is 32×32) whose QT level is 1 includes 128 pixels; and a minimum CU that may be obtained by performing BT split on a quadtree leaf node (a size is 16×16) whose QT level is 2 includes 32 pixels.

The following further describes the embodiments of this application in detail based on the foregoing design commonality of this application. In the embodiments of this application, an example in which a first leaf node is a binary tree leaf node is used for description.

The embodiments of this application provide an image decoding method, a video decoder, an image encoding method, a video encoder, and a video coding/decoding system. After obtaining a code stream corresponding to a CTU, the video decoder first obtains information about a binary tree leaf node obtained by splitting the CTU serving as a root node; then determines whether the information about the binary tree leaf node meets a preset split condition; when the information about the binary tree leaf node meets the split condition, obtains split instruction information of the binary tree leaf node from the code stream; and when the split instruction information of the binary tree leaf node is used to instruct to split the binary tree leaf node, obtains encoding information corresponding to a second leaf node obtained by splitting the binary tree leaf node serving as a root node. Subsequently, the video decoder generates, based on the encoding information corresponding to the second leaf node, a reconstructed image corresponding to the second leaf node, so as to obtain a reconstructed image corresponding to the CTU. The second leaf node is a leaf node obtained by splitting the binary tree leaf node serving as the root node. The binary tree leaf node may be split in a quadtree split manner, a ternary tree split manner, or the like. In this application, the quadtree split manner is used as an example for description.

According to the solutions provided in the embodiments of this application, a CU with a relatively large size may be further split without changing a maximum binary tree split level. When the binary tree leaf node meets the preset split condition, the node is further split into a code unit with a relatively small size based on the split instruction information of the node carried in the code stream. In this processing manner, encoding efficiency of some binary tree leaf nodes can be improved, and overall encoding complexity is not greatly affected. Therefore, this can achieve a balance between the encoding efficiency and the encoding complexity.

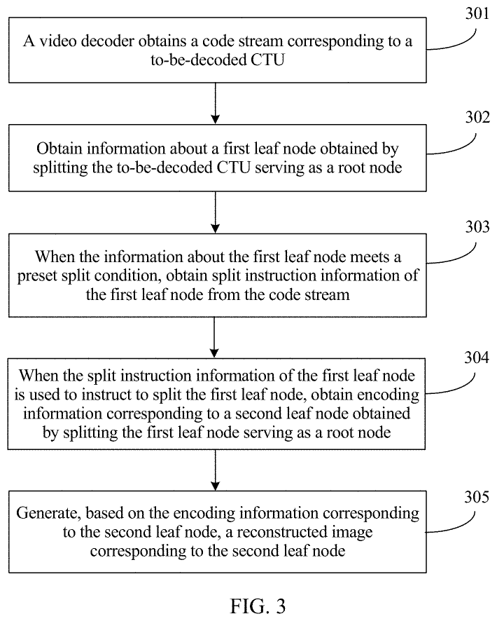

With reference to FIG. 3, the following describes an embodiment of an image decoding method in this application.

Step 301: A video decoder obtains a code stream corresponding to a to-be-decoded CTU.

One video code stream includes code streams respectively corresponding to a plurality of image frames, and one frame code stream may include code streams corresponding to a plurality of CTUs. After a CTU is decoded to generate a reconstructed image corresponding to the CTU, a next CTU is subsequently decoded.

In this embodiment of this application, a CTU that currently needs to be decoded is referred to as the to-be-decoded CTU.

A split tree corresponding to the CTU includes at least a binary tree node. The CTU split tree may be a binary tree, or may be a tree shape obtained by cascading a quadtree and a binary tree. For example, a split tree in the JEM is the tree shape obtained by cascading a quadtree and a binary tree.

Step 302: Obtain information about a first leaf node obtained by splitting the to-be-decoded CTU serving as a root node.

After obtaining the code stream corresponding to the to-be-decoded CTU, the video decoder parses information about a CTU split manner in the code stream to find the first leaf node obtained by splitting the CTU serving as the root node, and further obtains the information about the first leaf node.

The first leaf node includes but is not limited to a leaf node obtained through BT split, QTBT split, or the like. When the BT split or the QTBT split is performed, all first leaf nodes are binary tree leaf nodes. During the QTBT split, when binary tree split is not performed on a quadtree leaf node, the quadtree leaf node may also be considered as a binary tree leaf node. The second leaf node includes a leaf node obtained by splitting the first leaf node serving as the root node.

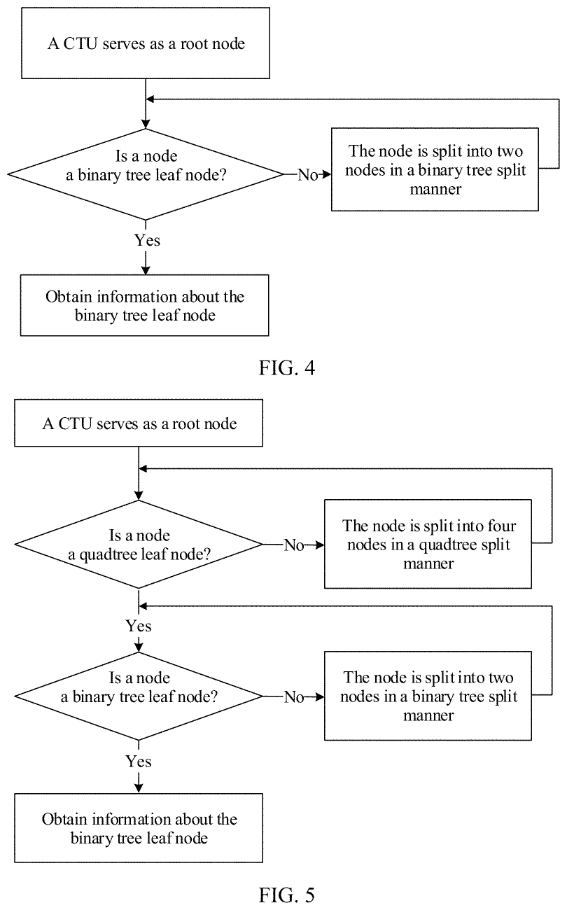

If the split tree corresponding to the CTU is a split tree formed in a BT split manner, refer to FIG. 4 for a processing process of searching for the first leaf node. If the split tree corresponding to the CTU is of a tree shape obtained by cascading a quadtree and a binary tree, refer to FIG. 5 for the processing process.

With reference to FIG. 4, the following further describes an embodiment of obtaining the first leaf node of the CTU through parsing from the CTU formed based on BT split.

As shown in FIG. 4, the CTU is first used as a binary tree root node, and a BT level of the root node is 0. Then, a node is recursively split in a binary tree manner based on binary tree split information corresponding to the node in the code stream, and each node may be split in one of the following three manners:

(1) When the binary tree split information indicates a first split manner, split is not performed, and the node is determined as a binary tree leaf node, namely, the first leaf node.

(2) When the binary tree split information indicates a second split manner, horizontal binary split is performed, and a node A is split into two subnodes of a same size. Widths of the two subnodes obtained through split are the same as a width of a parent node, heights are a half of a height of the parent node, and a BT level is obtained by increasing a BT level of the parent node by 1.

(3) When the binary tree split information indicates a third split manner, vertical binary split is performed, and a node A is split into two subnodes of a same size. Heights of the two subnodes obtained through split are the same as a height of a parent node, widths are a half of a width of the parent node, and a BT level is obtained by increasing a BT level of the parent node by 1.

The foregoing processing of determining a binary tree node split manner based on binary tree split information in a code stream is referred to as binary tree split determining processing. When a node is allowed to be further split into two nodes, binary tree split determining processing is performed on each of the two nodes, until a binary tree leaf node, namely, the first leaf node, is found. The binary tree split information may be represented by a three-valued syntactic element, such as BTSplitMode in the JEM.

With reference to FIG. 5, the following further describes an embodiment of obtaining the first leaf node of the CTU through parsing from the CTU formed based on QTBT split.

As shown in FIG. 5, the CTU is first used as a quadtree root node, and a QT level of the root node is 0. Then, a node is recursively split in a quadtree manner based on quadtree split information (for example, QTSplitMode in the JEM) corresponding to the node in the code stream, and each node may be split in one of the following two manners:

(1) When the quadtree split information indicates a first split manner, split is not performed, and the node is determined as a quadtree leaf node.

(2) When the quadtree split information indicates a second split manner, quadtree split is performed, and the node is split into four subnodes of a same size. Widths of the four subnodes obtained through split are a half of a width of a parent node, heights are a half of a height of the parent node, and a quadtree level is obtained by increasing a quadtree level of the parent node by 1.

The foregoing processing of determining a quadtree node split manner based on quadtree split information in a code stream is referred to as quadtree split determining processing. When the node is allowed to be further split into four nodes, quadtree split determining processing is performed on each of the four nodes, until a quadtree leaf node is found. The found quadtree leaf node serves as a binary tree root node, and a BT level is set to 0. Based on binary tree split information (for example, BTSplitMode in the JEM) corresponding to a node in the code stream, the node is recursively split in a binary tree manner, so as to find a binary tree leaf node, namely, the first leaf node. A QT level of the binary tree leaf node is equal to a QT level of the binary tree root node.

After the first leaf node is found, the information about the first leaf node may be obtained. The information about the first leaf node may include image-related data such as a width, a height, and coordinates of an image corresponding to the first leaf node, and may further include split level information of the first leaf node. For example, the split level information of the first leaf node obtained by splitting the CTU in a QTBT split manner in the JEM includes a QT level and a BT level.

In a process of searching for the first leaf node, the information about the first leaf node may be obtained through calculation in a layer-by-layer parameter transfer manner. For example, a size of a CTU is 64×64, and binary tree split is performed on the CTU to obtain the first leaf node. When binary tree split information of the root node indicates horizontal binary split, the root node is split into two first-layer subnodes of a same size, and widths of the two first-layer subnodes obtained through split are the same as a width of the root node (in other words, the widths are 64), heights are a half of a height of the root node (in other words, the heights are 32), and a BT level is 1. In addition, coordinate locations of the two first-layer subnodes may be further obtained through calculation. When the two first-layer subnodes are further split (in other words, a second-layer subnode of the CTU is obtained), information about the second-layer subnode may be obtained through calculation based on information about the first-layer subnode. For example, when binary tree split information of the first-layer subnode indicates vertical binary split, the first-layer subnode is split into two second-layer subnodes of a same size, heights of the two second-layer subnodes obtained through split are the same as the height of the first-layer subnode (in other words, the heights are 32), and widths are a half of the width of the first-layer subnode (in other words, the widths are 32), and a BT level is 2. In addition, coordinate locations of the two second-layer subnodes may be further obtained through calculation. In a split process, information about a node at each layer is calculated, and is transferred downward as a parameter, until the first leaf node is found. In other words, the information about the first leaf node may be obtained through calculation based on information about a parent node of the first leaf node.

Step 303: When the information about the first leaf node meets a preset split condition, obtain split instruction information of the first leaf node from the code stream.

For each found first leaf node, it is first determined whether the information about the first leaf node meets the preset split condition. If the information about the first leaf node does not meet the preset split condition, the node is determined as a CU, and a reconstructed image of the node is generated based on encoding information in the CU. If the first leaf node meets the preset split condition, the split instruction information of the first leaf node may be obtained by parsing a syntactic element included in the CTU.

In this embodiment, the first leaf node is a binary tree leaf node. The preset split condition includes but is not limited to at least one of the following conditions: An image corresponding to the binary tree leaf node is of a square shape; a BT level of the binary tree leaf node is greater than or equal to a first preset threshold; and a side length of the image corresponding to the binary tree leaf node or a logarithm of the side length to base 2 is greater than a second preset threshold.

A width of a square image is equal to a height. A square code unit may include luminance pixels in N rows and N columns; or may include chrominance pixels in N rows and N columns; or may include luminance pixels in N rows and N columns and chrominance pixels in N/2 rows and N/2 columns (for example, a YUV420 format); or may include luminance pixels in N rows and N columns and chrominance pixels in N rows and N columns (for example, a YUV444 format); or may include RGB pixels in N rows and N columns (for example, an RGB format).

It should be noted that, if the CU includes luminance pixels, a width and a height of the CU may be respectively represented by a width and a height of a luminance code block included in the CU; or if the CU includes only chrominance pixels, a width and a height of the CU may be respectively represented by a width and a height of a chrominance code block included in the CU.

The first preset threshold and the second preset threshold each may be set to a constant. For example, the first preset threshold is set to 2 or 4, and the second preset threshold is set to 4. The first preset threshold and the second preset threshold may be preset in the video decoder, or may be obtained by parsing the code stream.

For example, the first preset threshold and the second preset threshold may be identified in the SPS. The second preset threshold may be alternatively set to a minimum value of a CU side length (also referred to as a minimum CU side length, minimum CU size).

Step 304: When the split instruction information of the first leaf node is used to instruct to split the first leaf node, obtain encoding information corresponding to a second leaf node obtained by splitting the first leaf node serving as a root node.

In this embodiment, the first leaf node is a binary tree leaf node. The binary tree leaf node may be split in a quadtree split manner, a ternary tree split manner, or the like. During specific implementation, the quadtree split manner is preferred.

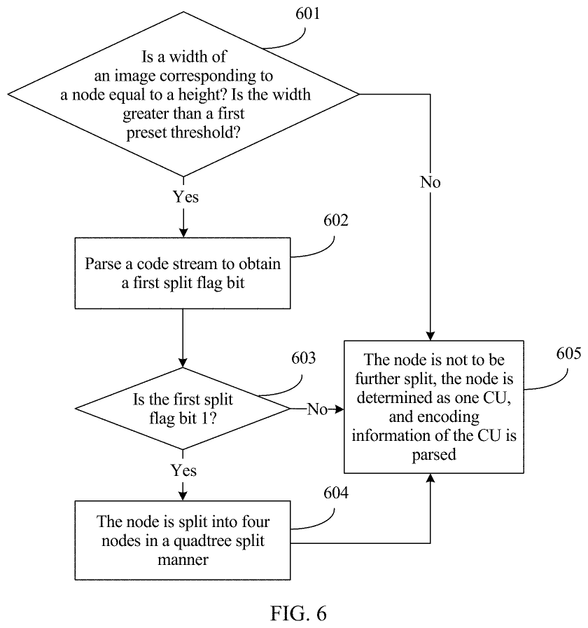

With reference to FIG. 6, the following further describes an embodiment of performing at-most-one-layer split on a binary tree leaf node in this application.

Step 601: Determine whether information about the binary tree leaf node meets a preset split condition; and if yes, perform processing in step 602; otherwise, perform processing in step 605.

In this embodiment, the preset split condition is that an image corresponding to the binary tree leaf node is of a square shape and a width of the image corresponding to the binary tree leaf node is greater than a preset minimum CU width. A video decoder determines the information about the binary tree leaf node in two aspects. In one aspect, the video decoder determines whether the width of the image corresponding to the node is equal to a height, so as to determine whether the image corresponding to the node is of a square shape. In the other aspect, the video decoder determines whether the width of the image corresponding to the node is greater than a second preset threshold TX. It is determined that the information about the binary tree leaf node meets the preset split condition only when the image corresponding to the node is of a square shape and the width of the image corresponding to the node is greater than the second preset threshold.

Step 602: Parse a code stream to obtain a first split flag bit of the binary tree leaf node, where the first split flag bit includes split instruction information of the node.

The code stream is parsed to obtain the first split flag bit corresponding to the binary tree leaf node. If the first split flag bit is a first preset value (for example, 0), it is determined that the binary tree leaf node is not to be further split, and the node is a CU; or if the first split flag bit is a second preset value (for example, 1), the binary tree leaf node is split into four quadtree leaf nodes of a same size in a quadtree split manner, and each quadtree leaf node is one CU.

The first split flag bit may be a binary flag bit, for example, is named sQtSplitFlag. When a value of the first split flag bit is 1 (or 0), it indicates that the node is to be split into four nodes in a quadtree manner; or when a value of the first split flag bit is 0 (or 1), it indicates that the node is not to be further split. The first split flag bit may follow a syntactic element BtSplitMode that represents binary tree split information.

The first split flag bit may be obtained through parsing in a context-adaptive binary arithmetic coding (context-based adaptive binary arithmetic coding, CABAC) manner. A context model of the algorithm may be implemented in a plurality of manners: The context model may correspond to only one context model; or the context model may be a corresponding context model used based on a binary tree level of the node; or the context model may be a corresponding context model used based on a quadtree level and a binary tree level of the node; or the context model may be a corresponding context model used based on a size of the node.

Step 603: Determine whether the first split flag bit is 1; and if yes, perform processing in step 604; otherwise, perform processing in step 605.

Step 604: Split, in a quadtree split manner, the binary tree leaf node into CUs corresponding to four quadtree leaf nodes.

Step 605: Determine that the node is not to be further split, use the node as a code unit, and obtain encoding information corresponding to the CU.

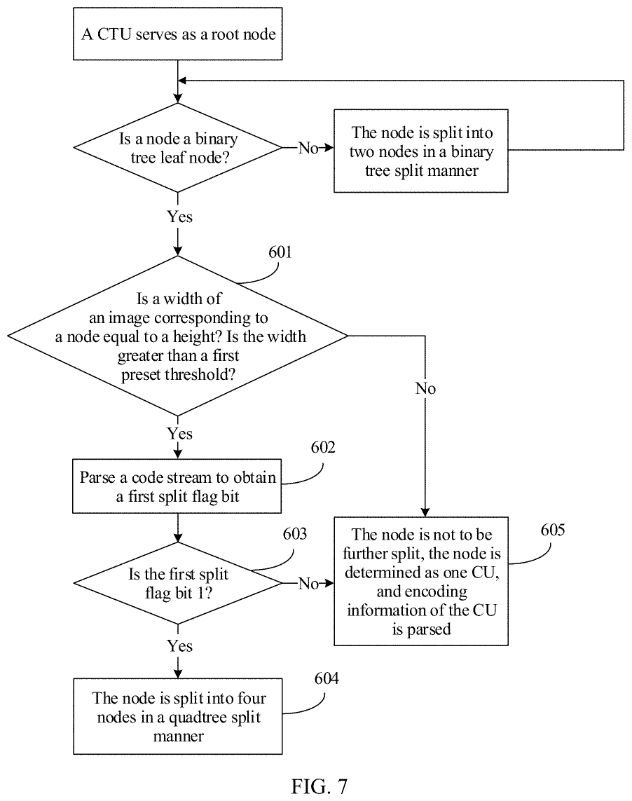

By combining FIG. 4 and FIG. 6 or by combining FIG. 5 and FIG. 6, an entire processing process of finding a second leaf node from a CTU root node can be implemented. As shown in FIG. 7, a CTU in the figure is a CTU formed in a BT split manner, and at-most-one-layer split is performed on a binary tree leaf node.

To more intuitively describe the implementation shown in FIG. 7, the following further describes this implementation with reference to Table 1 and Table 2.

TABLE 1
Syntax example table of a binary tree split syntax structure

| coding_binarytree(x0, y0, cuWidth, cuHeight, btDepth, ...) { | Descriptor |
|---|---|
| if(condA) | |
| BtSplitMode[x0][y0] | ae(v) |
| if(btSplitMode[x0][y0] == 1) { | |
| y1 = y0 + (cuHeight>>1) | |
| coding_binarytree(x0, y0, cuWidth, cuHeight>>1, | |
| btDepth+1, ...) | |
| coding_binarytree(x0, y1, cuWidth, cuHeight>>1, | |
| btDepth+1, ...) | |
| } | |
| else if(btSplitMode[x0][y0] == 2) { | |
| x1 = x0 + (cuWidth>>1) | |
| coding_binarytree(x0, y0, cuWidth>>1, cuHeight, | |
| btDepth+1, ...) | |
| coding_binarytree(x1, y0, cuWidth>>1, cuHeight, | |
| btDepth+1, ...) | |
| } | |
| else{ | |
| if(cuWidth == cuHeight && cuWidth > TX) { | |
| sQtSplitFlag[x0][y0] | ae(v) |
| if(sQtSplitFlag[x0][y0]) { | |
| x1 = x0 + (cuWidth>>1) | |
| y1 = y0 + (cuHeight>>1) | |
| coding_unit(x0, y0, cuWidth>>1, cuHeight>>1, btDepth, ...) | |
| coding_unit(x1, y0, cuWidth>>1, cuHeight>>1, btDepth, ...) | |
| coding_unit(x0, y1, cuWidth>>1, cuHeight>>1, btDepth, ...) | |
| coding_unit(x1, y1, cuWidth>>1, cuHeight>>1, btDepth, ...) | |
| } | |
| else | |
| coding_unit(x0, y0, cuWidth, cuHeight, btDepth, ...) | |
| } | |
| else | |
| coding_unit(x0, y0, cuWidth, cuHeight, btDepth, ...) | |
| } | |
| } | |

Table 1 provides a syntax table example of a binary tree split syntax structure including quadtree split information sQtSplitFlag. In this syntax organization, if a width of a square node obtained in a binary tree manner is greater than the second preset threshold TX, a quadtree split identifier sQtSplitFlag appears in the code stream. When sQtSplitFlag is 0, it indicates that the binary tree leaf node is not to be further split (in other words, the node is a quadtree leaf node using the binary tree leaf node as the root node) and is determined as one CU. When sQtSplitFlag is 1, it indicates that the node is to be split into four leaf nodes in a quadtree manner, and each leaf node is determined as one CU.

In Table 1, coding_binarytree( ) is a binary tree split syntax structure in which a specific manner of performing binary tree split on a binary tree node is described, where x0, x1, cuWidth, cuHeight, and btDepth are variables; x0 represents an upper-left (in other words, an upper-left image region corresponding to the node) horizontal offset of the node relative to that of the CTU, and x1 represents an upper-left vertical offset of the node relative to that of the CTU (one pixel is used as a unit); cuWidth and cuHeight respectively represent a width and a height of the CU (one pixel is used as a unit); btDepth represents a BT level of the CU; and “ . . . ” represents another variable that may be required. For example, when the CTU is split in a QTBT manner, a QT level of a node in a quadtree using the CTU as the root node may be further included herein. The condition condA represents a condition in which a binary tree split information syntactic element BtSplitMode appears in a code stream. For example, the condition condA is btDepth<MaxBTDepth && (cuWidth>minBTSize∥cuHeight>minBtSize) && (cuWidth<=maxBTSize && cuHeight<=maxBTSize), where MaxBTDepth is a preset parameter and represents a maximum binary tree level, and a value of MaxBTDepth is an integer greater than 0 (such as 2, 3, or 4) and may be preset or obtained through parsing from the SPS; minBTSize is a preset parameter and represents a minimum value of a side length of a binary tree node, and a value of minBTSize is an integer greater than 0 (such as 4 or 8) and may be preset or obtained through parsing from the SPS; maxBTSize is a preset parameter and represents a maximum value of a side length of a binary tree node, and a value of maxBTSize is an integer greater than minBTSize (such as 64 or 128) and may be preset or obtained through parsing from the SPS; “&&” indicates a logical operator “and”; “∥” indicates a logical operator “or”; “X>>Y” indicates that X is shifted rightward by Y bits; and ae(v) indicates that decoding is performed through CABAC.

In this embodiment, a value of BtSplitMode is 0, 1, or 2. When BtSplitMode is 1, it indicates that the node is to be split into two nodes through horizontal binary split, it is still not determined whether the two nodes are to be split, and split of the two nodes is further separately determined by parsing syntax coding_binarytree( ) When BtSplitMode is 2, it indicates that the node is to be split into two nodes through vertical binary split, it is still not determined whether the two nodes are to be split, and split of the two nodes is further separately determined by parsing syntax coding_binarytree( ) When BtSplitMode is 0 (in other words, when BtSplitMode is neither 1 nor 2 in Table 1), it indicates that the node is not to be further split in a binary tree manner, and the node is a binary tree leaf node (that is, the first leaf node). In this case, there may be two branches for processing:

Branch 1: If a condition that “a width and a height of a node are equal, and the width of the node is greater than the second preset threshold TX” is met, a syntactic element sQtSplitFlag[x0][y0] is parsed from the code stream. If sQtSplitFlag[x0][y0] is 1, the node is to be split into four nodes of a same size (that is, second leaf nodes) through quadtree split. In addition, it is determined that the four nodes are not to be further split. Each quadtree node corresponds to one CU, and CU syntax structures coding_unit( ) of respective four CUs are separately parsed to obtain encoding information such as a prediction mode and a transform coefficient. A sequence of parsing the four CUs may be a zig-zag scan sequence: an upper-left CU, an upper-right CU, a lower-left CU, and a lower-right CU. If sQtSplitFlag[x0][y0] is 0, it is determined that the node is not to be further split, and the node corresponds to one CU. In this case, a syntax structure coding_unit( ) of the CU is parsed to obtain encoding information of the CU.

Branch 2: If a condition that “a width and a height of a node are equal, and the width of the node is greater than the second preset threshold TX” is not met, it is determined that the node is not to be split, and the node is a second leaf node and corresponds to one CU. In this case, a syntax structure coding_unit( ) of the CU is parsed to obtain encoding information of the CU.

Herein, coding_unit( ) describes encoding information (such as a prediction mode and a residual) of a CU. According to the information, the CU may be decoded, so as to obtain reconstructed pixels of the CU through reconstruction. When BtSplitMode does not appear in the code stream, a value of BtSplitMode is 0 by default. In other words, the binary tree node is not to be further split, and the node is a binary tree leaf node (that is, the first leaf node). When sQtSplitFlag does not appear in the code stream, a value of sQtSplitFlag is 0 by default. In other words, the binary tree leaf node is not to be further split in a quadtree manner.

During specific implementation, cuWidth and cuHeight are usually 2 raised to the power of an integer. In other words, cuWidth=2\hat{ }log 2CuWidth, cuHeight=2\hat{ }log 2CuHeight, where “X\hat{ }Y” is X raised to the power of Y. If log 2CuWidth and log 2CuHeight are used as variables to respectively replace cuWidth and cuHeight, Table 1 may be rewritten to Table 2.

TABLE 2
Still another syntax example table of a binary tree split syntax structure

| coding_binarytree(x0, y0, log2CuWidth, | |
|---|---|
| log2CuHeight, btDepth, ...) { | Descriptor |
| if(condA) | |
| BtSplitMode[x0][y0] | ae(v) |
| if(btSplitMode[x0][y0] == 1) { | |
| y1 = y0 + (1<<(log2CuHeight − 1)) | |
| coding_binarytree(x0, y0, log2CuWidth, | |
| log2CuHeight − 1, btDepth + 1, ...) | |
| coding_binarytree(x0, y1, log2CuWidth, | |
| log2CuHeight − 1, btDepth + 1, ...) | |
| } | |
| else if(btSplitMode[x0][y0] == 2) { | |
| x1 = x0 + (1<<(log2CuWidth − 1)) | |
| coding_binarytree(x0, y0, log2CuWidth − 1, | |
| log2CuHeight, btDepth + 1, ...) | |
| coding_binarytree(x1, y0, log2CuWidth − 1, | |
| log2CuHeight, btDepth + 1, ...) | |
| } | |
| else{ | |
| if(log2CuWidth == log2CuHeight && log2CuWidth | |
| > log2TX) { | |
| sQtSplitFlag[x0][y0] | ae(v) |
| if(sQtSplitFlag[x0][y0]) { | |
| x1 = x0 + (1<<(log2CuWidth − 1)) | |
| y1 = y0 + (1<<(log2CuHeight − 1)) | |
| coding_unit(x0, y0, log2CuWidth − 1, | |
| log2CuHeight − 1, btDepth, ...) | |
| coding_unit(x1, y0, log2CuWidth − 1, | |
| log2CuHeight − 1, btDepth, ...) | |
| coding_unit(x0, y1, log2CuWidth − 1, | |
| log2CuHeight − 1, btDepth, ...) | |
| coding_unit(x1, y1, log2CuWidth − 1, | |
| log2CuHeight − 1, btDepth, ...) | |
| } | |
| else | |
| coding_unit(x0, y0, log2CuWidth, | |
| log2CuHeight, btDepth, ...) | |
| } | |
| else | |
| coding_unit(x0, y0, log2CuWidth, | |
| log2CuHeight, btDepth, ...) | |
| } | |
| } | |

In Table 2, “X<<Y” represents an operation of shifting X leftward by Y bits; and log 2TX is a logarithm of the second preset threshold to base 2, and a value of log 2TX is a positive integer, for example, 2 or 3, or log 2TX is a logarithm of a minimum CU side length to base 2.

In an optional implementation, if a binary tree leaf node (the first leaf node) is split based on quadtree recursive split in an encoding phase, the video decoder needs to use the binary tree leaf node as a quadtree root node, and parses a quadtree split syntax structure from the code stream to obtain a quadtree leaf node, namely, the second leaf node. A difference between this implementation and the foregoing implementation of performing at-most-one-layer split on a binary tree leaf node is that at-least-two layer split is performed on the binary tree leaf node to obtain the second leaf node. Four quadtree nodes obtained by splitting the binary tree leaf node are not necessarily second leaf nodes, and the quadtree nodes are allowed to be further split into a plurality of smaller CUs in a quadtree split manner. In this processing manner, a code unit with a relatively small size is further obtained through split. Therefore, encoding efficiency can be further improved in a region having a complex texture.

The quadtree split syntax structure includes a second split flag bit. If the second split flag bit is a third preset value (for example, 0), it is determined that the quadtree node is not to be further split, one CU is formed, and encoding information of the CU is parsed. If the second split flag bit is a fourth preset value (for example, 1), the quadtree node is further split into four quadtree nodes of a same size in a quadtree split manner, and a quadtree split syntax structure of each quadtree node is further parsed to determine a split manner of the quadtree node, until the second leaf node is found.

The foregoing step in which “the binary tree leaf node serves as a quadtree root node, and a quadtree split syntax structure is parsed from the code stream to obtain a quadtree leaf node” may be implemented in the following manner: First, the binary tree leaf node serves as the quadtree root node, and a level of the binary tree leaf node is set to 0. Then, for a node whose level is 0, a second split flag bit corresponding to the node is parsed, for example, is named 1QtSplitFlag. If a value of the second split flag bit is 0, the node is not to be further split; otherwise, the node whose level is 0 is split into four nodes whose levels are 1, and a width and a height of each node are a half of those of the upper-level node (that is, the parent node). If a node whose level is 0 is split, each node whose level is 1 is obtained through split, and a second split flag bit corresponding to the node is further parsed to determine whether the node is not to be split or whether to split the node into four nodes whose level is 2 in a quadtree manner. If a node whose level is 1 is split, a second split flag bit corresponding to each node whose level is 2 and that is obtained through split is parsed to determine whether the node is not to be split or whether to split the node into four nodes whose level is 3 and that are obtained in a quadtree manner. Similar operations are performed based on such a quadtree recursive structure, until all nodes are not to be further split.

It should be noted that, if an implementation in which “when a node does not meet a preset recursive split condition, the node is not to be further split by default, and a second split flag bit corresponding to the node is not written into the code stream” is used in an encoding phase, in the foregoing node split parsing process, if it is needs to be determined whether a node is to be further split, it may be first determined whether the node meets the preset recursive split condition. When it is determined that the node does not meet the preset recursive split condition, it may be directly determined that the node is not to be further split, the second split flag bit corresponding to the node does not need to be parsed from the code stream, and then it is determined, based on the second split flag bit, whether the node is to be further split. When it is determined that the node meets the preset recursive split condition, the second split flag bit corresponding to the node is parsed from the code stream.

The preset recursive split condition includes but is not limited to the following conditions: A recursive split level of the node is less than a third preset threshold; a side length of an image corresponding to the node is greater than a fourth preset threshold; and a recursive split level of the node is less than a third preset threshold and a side length of the image corresponding to the node is greater than a fourth preset threshold.

The third preset threshold may be set to an integer greater than or equal to 0. The third preset threshold may be a constant (such as 2 or 3) preset by the video decoder, or may be obtained by parsing the code stream, or may be determined based on a BT level of the node.

To obtain the third preset threshold by parsing the code stream, the video encoder needs to write, in the encoding phase, a syntactic element corresponding to the third preset threshold into a syntax structure such as the SPS, a PPS (Picture Parameter Set, picture parameter set), a slice header (slice header), or a slice segment header (slice segment header). Correspondingly, the video decoder needs to parse, in a decoding phase, the syntactic element in the syntax structure including the syntactic element, and obtains the third preset threshold based on a value of the syntactic element. For example, values 0, 1, and 2 of the syntactic element corresponding to the third preset threshold respectively indicate that the third preset threshold is 0, 1, and 2, or respectively indicate that the third preset threshold is 1, 2, and 3.

To determine the third preset threshold based on a binary tree level of a node, a mapping relationship between a binary tree level of the node and the third preset threshold needs to be preset. For example, if the binary tree level of the node is less than or equal to a fifth preset threshold, the third preset threshold is 2; otherwise, the third preset threshold is 1. Alternatively, if the binary tree level of the node is greater than or equal to a sixth preset threshold, the third preset threshold is 1; otherwise, the third preset threshold is 0. The fifth preset threshold and the sixth preset threshold each may be set to an integer greater than or equal to 0, for example, 2, 3, or 4.

Same with the third preset threshold, the fourth preset threshold may also be set to an integer greater than or equal to 0. Similarly, the fourth preset threshold may be a constant (such as 4 or 8) preset by the video decoder, or may be equal to a preset minimum code unit side length, or may be obtained by parsing the code stream. For example, the video encoder sets a value of a syntactic element B in the SPS in an encoding phase, and the decoder parses the value of the syntactic element B in a decoding phase. Values 0, 1, and 2 of the syntactic element B respectively indicate that the fourth preset threshold is a minimum code unit side length, two times greater than a minimum code unit side length, and four times greater than a minimum code unit side length.

To more intuitively describe the foregoing steps in which “the binary tree leaf node serves as a quadtree root node, and a quadtree split syntax structure is parsed from the code stream to obtain a quadtree leaf node”, the following describes this implementation with reference to Table 3 and Table 4.

TABLE 3
Still another syntax example table of a binary tree split syntax structure

| coding_binarytree(x0, y0, log2CuWidth, | |
|---|---|
| log2CuHeight, btDepth, ...) { | Descriptor |
| if(condA) | |
| BtSplitMode[x0][y0] | ae(v) |
| if(btSplitMode[x0][y0] == 0) { | |
| y1 = y0 + (1<<(log2CuHeight − 1)) | |
| coding_binarytree(x0, y0, log2CuWidth, log2CuHeight − 1, | |
| btDepth + 1, ...) | |
| coding_binarytree(x0, y1, log2CuWidth, log2CuHeight − 1, | |
| btDepth + 1, ...) | |
| } | |
| else if(btSplitMode[x0][y0] == 1) { | |
| x1 = x0 + (1<<(log2CuWidth −1)) | |
| coding_binarytree(x0, y0, log2CuWidth − 1, log2CuHeight, | |
| btDepth + 1, ...) | |
| coding_binarytree(x1, y0, log2CuWidth − 1, log2CuHeight, | |
| btDepth + 1, ...) | |
| } | |
| else{ | |
| if(log2CuWidth == log2CuHeight && log2CuWidth | |
| > log2TX) | |
| coding_lquadtree(x0, y0, og2CuWidth, btDepth, 0) | |
| else | |
| coding_unit(x0, y0, log2CuWidth, log2CuHeight, | |
| btDepth, ...) | |
| } | |
| } | |

TABLE 4
Syntax table of a quadtree split syntax structure

| coding_lquadtree(x0, y0, log2CbSize, btDepth, depth) { | Descriptor |
|---|---|
| if(condB) | |
| lQtSplitFlag[x0][y0] | ae(v) |
| if(lQtSplitFlag[x0][y0]) { | |
| x1 = x0 + (1<<(log2CbSize − 1)) | |
| y1 = y0 + (1<<(log2CbSize − 1)) | |
| coding_lquadtree(x0, y0, log2CbSize − 1, | |
| btDepth, depth + 1) | |
| coding_lquadtree(x1, y0, log2CbSize − 1, | |
| btDepth, depth + 1) | |
| coding_lquadtree(x0, y1, log2CbSize − 1, | |
| btDepth, depth + 1) | |
| coding_lquadtree(x1, y1, log2CbSize − 1, | |
| btDepth, depth + 1) | |
| }else | |
| coding_unit(x0, y0, log2CbSize, log2CbSize, btDepth, ...) | |
| } | |

Table 3 provides a syntax table example of the binary tree split syntax structure coding_binarytree( ) corresponding to the foregoing optional implementation. Table 4 provides a syntax table example of the quadtree split syntax structure coding_binarytree( ) corresponding to the foregoing optional implementation. Herein, coding_binarytree( ) in Table 3 is similar to coding_binarytree( ) in Table 2. However, the quadtree split syntax structure coding_lquadtree( ) shown in Table 4 is invoked in Table 3, and coding_lquadtree( ) includes a second split flag bit indicating whether to perform quadtree split, namely, 1QtSplitFlag.

In Table 4, log 2CbSize represents a width of a node, and depth is a recursive split level of the node. When the preset recursive split condition condB is false, the node is not to be further split by default, and 1QtSplitFlag does not appear in the code stream. When condB is true, 1QtSplitFlag corresponding to the node needs to be parsed to determine whether to perform quadtree split on the node. If the quadtree split is performed on the node, split of each next-level node obtained through split is still not determined, and a quadtree split syntax structure of each next-level node needs to be further recursively parsed to determine a split manner of each next-level node.

Step 305: Generate, based on the encoding information corresponding to the second leaf node, a reconstructed image corresponding to the second leaf node.

The second leaf node serves as a CU, and the second leaf node is decoded based on the encoding information of the second leaf node to generate the corresponding reconstructed image. Reconstructed images respectively corresponding to code units included in the CTU form a reconstructed image of the CTU.

A decoding process performed by the code unit may include processing steps such as entropy decoding, dequantization, inverse transformation, prediction, and loop filtering. In this embodiment, the decoding process is as follows: (1) Entropy decoding is performed to obtain encoding information of the code unit such as a prediction mode, a quantization parameter, a transform coefficient, and a transform mode; (2) intra-frame prediction or inter prediction is selected based on the prediction mode to obtain predicted pixels of the code unit; (3) if the code unit includes the transform coefficient, dequantization and inverse transformation processing are performed on the transform coefficient based on the quantization parameter and the transform mode to obtain a reconstruction residual of the code unit; or if the code unit does not include the transform coefficient, a reconstruction residual of the code unit is 0, in other words, values of reconstruction residuals of pixels in the encode unit are all 0; and (4) loop filtering processing is performed after the predicted pixels and the reconstruction residual are added, to obtain the reconstructed pixels of the code unit.

It can be learned from the foregoing embodiment that, according to the image decoding method provided in the embodiment of this application, a CU with a relatively large size can be further split without changing a maximum binary tree split level. When the binary tree leaf node meets the preset split condition, the node is further split into a code unit with a relatively small size based on the split instruction information of the node carried in the code stream. In this processing manner, encoding efficiency of some binary tree leaf nodes can be improved, and encoding complexity is not greatly affected. Therefore, this can achieve a balance between the encoding efficiency and the encoding complexity.

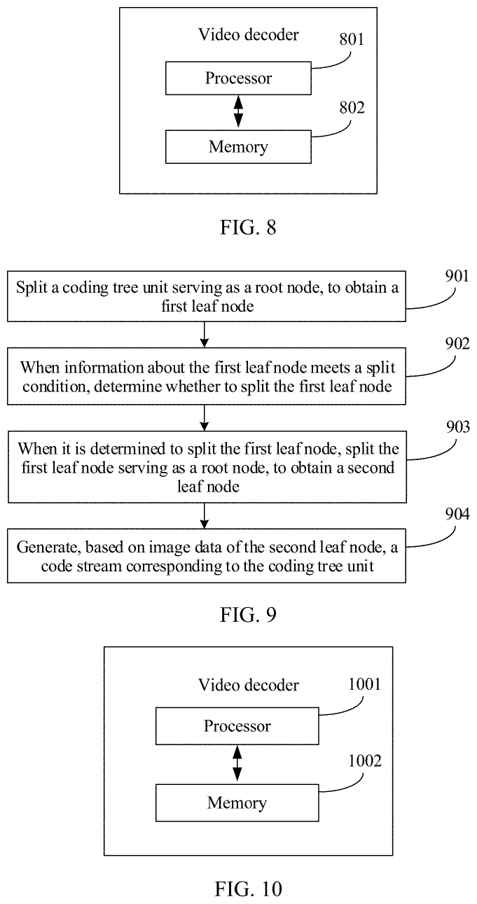

FIG. 8 is a block diagram of a video decoder in the foregoing embodiments.

The video decoder includes a processor 801 and a memory 802. The processor 801 performs a processing process of the video decoder in FIG. 3 to FIG. 7 and/or performs another process in the technology described in this application. The memory 802 is configured to store program code and data of the video decoder.

Optionally, the video decoder may further include a receiver. The receiver is configured to: receive a code stream corresponding to a to-be-decoded CTU sent by a video encoder; and send the code stream to the processor 801 to generate a reconstructed image corresponding to the CTU.

It can be understood that FIG. 8 is merely a simplified design for processing the video decoder. It can be understood that the video decoder may include any quantity of processors, memories, receivers, and the like.

Corresponding to the image decoding method in this application, this application further provides an image encoding method.

With reference to FIG. 9, the following describes an embodiment of an image encoding method in this application.

Step 901: Split a coding tree unit serving as a root node, to obtain a first leaf node.

In this embodiment, the first leaf node is a binary tree leaf node. The binary tree leaf node may be a binary tree leaf node obtained by splitting the CTU in a binary tree (BT) manner, or may be a binary tree leaf node obtained by splitting the CTU by cascading a quadtree and a binary tree (QTBT). If a quadtree leaf node generated by cascading a quadtree and a binary tree is not to be further split in a binary tree manner, the quadtree leaf node is a binary tree leaf node.

To obtain the first leaf node by splitting the coding tree unit as a root node, a CTU split manner including binary tree split first needs to be selected from a plurality of CTU split manners. The CTU split manner including binary tree split may be based on BT split or based on QTBT split.

The CTU split manner including binary tree split may be selected from the plurality of CTU split manner by performing the following steps: (1) The CTU is split into a group of CUs based on each CTU split, and each CU is encoded to obtain a rate-distortion cost of the CTU under the CTU split; and (2) A CTU with a minimum rate-distortion cost is split as an optimal CTU.

A rate-distortion cost corresponding to the CTU split is a sum of rate-distortion costs of all CUs obtained through the CTU split. A rate-distortion cost of one CU is calculated by using a common technology, and the rate-distortion cost is usually a weighted sum of a sum of squared errors (sum of squared errors, SSE for short) of reconstruction distortion of pixels included in the CU and an estimation values of a bit quantity of a code stream corresponding to the CU. Alternatively, it may be simplified that the rate-distortion cost is related to only reconstruction distortion of pixels included in the CU and unrelated to the quantity of bits of the CU.

After the CTU split manner is determined, the first leaf node may be obtained by splitting the coding tree unit as a root node in the split manner.

Step 902: When information about the first leaf node meets a split condition, determine whether to split the first leaf node.

After the CTU serving as the root node is split to obtain the first leaf node, the first leaf node that meets the preset split condition may be found based on the preset split condition. In this embodiment, the first leaf node is a binary tree leaf node. Correspondingly, the preset split condition may include at least one of the following conditions: An image corresponding to the binary tree leaf node is of a square image; a binary tree level of the binary tree leaf node is greater than or equal to a first preset threshold; and a side length of the image corresponding to the binary tree leaf node or a logarithm of the side length to base 2 is greater than a second preset threshold. The split condition is described in detail in Embodiment 1, and details are not described herein again. For details, refer to related descriptions in Embodiment 1.

After the binary tree leaf node that meets the preset split condition is found from a split tree corresponding to the CTU, a rate-distortion cost of CU encoding generated when one-layer quadtree split is performed and a rate-distortion cost of CU encoding generated when no split is performed are compared for each binary tree leaf node that meets the condition, and it is determined, based on a comparison result, whether the node is to be further split.

During specific implementation, a process of determining whether to split the first leaf node may include the following steps: (1) A rate-distortion cost generated before the binary tree leaf node is split is used as a first rate-distortion cost; (2) the node is further split into four next-level nodes according to a quadtree, the four next-level nodes are sequentially encoded, and a sum of respective rate-distortion costs is calculated for use as a second rate-distortion cost generated after the binary tree leaf node is split; and (3) if the first rate-distortion cost is less than or equal to the second rate-distortion cost, it is determined that the binary tree leaf node is not to be further split; otherwise, it is determined that the node is to be further split into four leaf nodes in a quadtree manner.

Step 903: When it is determined to split the first leaf node, split the first leaf node serving as a root node, to obtain a second leaf node.

In this embodiment, the second leaf node is a leaf node obtained by splitting the first leaf node serving as the root node in a quadtree manner. During specific implementation, in a ternary tree split manner, an octree split manner, or the like, the first leaf node serving as the root node is split, to obtain the second leaf node.

There are two manners of splitting the first leaf node serving as the root node, to obtain the second leaf node: (1) One-layer split is performed on the first leaf node to obtain the second leaf node; and (2) At-least-two-layer split is performed on the first leaf node to obtain the second leaf node.

To perform at-least-two-layer split on the first leaf node to obtain the second leaf node, the following steps may be used for processing: First, one-layer split is performed on the first leaf node to obtain a current node; it is successively determined whether each current node is to be further split; and when it is determined to split the current node, the current node is split to obtain the second leaf node.

Whether to further split the current node may still be determined by comparing rate-distortion costs generated before and after split. In addition, when the information about the current node meets the preset recursive split condition, it may be determined to split whether the current node. In this processing manner, when the information about the current node does not meet the preset recursive split condition, the split instruction information of the node does not need to be set in the code stream, thereby further improving encoding efficiency.

The preset recursive split condition may include but is not limited to at least one of the following conditions: A recursive split level of the current node is less than a third preset threshold; and a side length of an image corresponding to the current node or a logarithm of the side length to base 2 is greater than a fourth preset threshold. The recursive split condition is described in detail in Embodiment 1, and details are not described herein again. For details, refer to related descriptions in Embodiment 1.

Step 904: Generate, based on image data of the second leaf node, a code stream corresponding to the coding tree unit.

After the CTU is split into the second leaf node, the second leaf node serves as a CU, and corresponding encoding information may be generated based on image data of the CU. Encoding information of a plurality of CUs constitutes a code stream corresponding to the CTU. The code stream corresponding to the CTU includes not only encoding information corresponding to the second leaf node, but also the split instruction information of the first leaf node. When it is determined to split the first leaf node, the split instruction information of the first leaf node is used to instruct to split the first leaf node.

When the information about the first leaf node meets the preset split condition, but whether to split the first leaf node is not determined in step 902, the first leaf node serves as a CU, and corresponding encoding information is generated based on the image data of the first leaf node. In this case, the code stream corresponding to the CTU includes the encoding information corresponding to the second leaf node and the split instruction information of the first leaf node, and the split instruction information of the first leaf node is used to instruct not to split the first leaf node.

The split instruction information of the first leaf node may be organized in a syntax organization manner described in Table 1, Table 2, Table 3, or Table 4.

When the information about the first leaf node does not meet the preset split condition, the first leaf node serves as a CU, and corresponding encoding information is generated based on the image data of the first leaf node. In this case, the code stream corresponding to the CTU includes the encoding information corresponding to the first leaf node, but may not include the split instruction information of the first leaf node. In other words, when the information about the first leaf node does not meet the preset split condition, the split instruction information of the first leaf node does not need to be set.

A CU encoding process may include processing steps such as prediction, transformation, quantization, and entropy encoding. In this embodiment, the processing process includes the following steps: (1) Intra-frame prediction or inter prediction is selected based on a prediction mode to obtain predicted pixels of the CU; (2) a residual between original pixels and predicted pixels of the CU is transformed and quantized to obtain a transform coefficient, and the transform coefficient is dequantized and inversely transformed to obtain a reconstruction residual; (3) the predicted pixels and the reconstruction residual of the CU are added to perform loop filtering processing to obtain reconstructed pixels of the CU; and (4) entropy encoding is performed on information about the CU such as the prediction mode and the transform coefficient, to generate a code stream of the CU. Finally, a code stream corresponding to the CTU includes the code stream of each CU.

It can be learned from the foregoing embodiments that, according to the image encoding method provided in the embodiments of this application, an image (CU) with a relatively large size can be further split without changing a maximum binary tree split level. When the binary tree leaf node meets the preset split condition, the image corresponding to the binary tree leaf node is further split to form an image with a relatively small size. In this processing manner, encoding efficiency of some binary tree leaf nodes can be improved, and encoding complexity is not greatly affected. Therefore, this can achieve a balance between the encoding efficiency and the encoding complexity.

FIG. 10 is a block diagram of a video encoder in the foregoing embodiments.

The video encoder includes a processor 1001 and a memory 1002. The processor 1001 performs a processing process of the video encoder in FIG. 9 and/or another process in the technology described in this application. The memory 1002 is configured to store program code and data of the video encoder.

Optionally, the video encoder may further include a transmitter. The transmitter is configured to send, to the video decoder in the foregoing embodiments, a code stream that corresponds to the CTU and that is output by the processor 1001.

It can be understood that FIG. 10 is merely a simplified design for processing the video encoder. It can be understood that the video decoder may include any quantity of processors, memories, transmitters, and the like.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer instructions. When the computer program instructions are loaded and executed on a computer, the procedures or functions according to the embodiments of this application are all or partially generated. The computer may be a general-purpose computer, a special-purpose computer, a computer network, or another programmable apparatus. The computer instructions may be stored in a computer readable storage medium, or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state drive solid state disk (SSD)), or the like.

For same or similar parts in the embodiments in this specification, refer to these embodiments. Especially, video decoder and video encoder embodiments are basically similar to the method embodiment, and therefore are briefly described. For related parts, refer to descriptions in the method embodiment.

The foregoing descriptions are implementations of this application, but are not intended to limit the protection scope of this application.

What is claimed is:

1. An image decoding method, wherein the method comprises:
obtaining information about a first leaf node obtained by splitting a coding tree unit serving as a root node;
when the information about the first leaf node meets a split condition, obtaining split instruction information of the first leaf node;
when the split instruction information of the first leaf node is used to instruct to split the first leaf node, obtaining encoding information corresponding to a second leaf node obtained by splitting the first leaf node serving as a root node; and
generating, based on the encoding information corresponding to the second leaf node, a reconstructed image corresponding to the second leaf node.

2. The method according to claim 1, wherein the first leaf node is a leaf node obtained by splitting the coding tree unit serving as the root node in a binary tree manner or in a manner of cascading a quadtree and a binary tree, and the split condition comprises at least one of the following conditions:
an image corresponding to the first leaf node is of a square shape; a binary tree level of the first leaf node is greater than or equal to a first preset threshold; and a side length of the image corresponding to the first leaf node or a logarithm of the side length to base 2 is greater than a second preset threshold.

3. The method according to claim 1, wherein the second leaf node is a leaf node obtained by splitting the first leaf node serving as the root node in a quadtree manner.

4. The method according to claim 1, wherein the obtaining encoding information corresponding to a second leaf node obtained by splitting the first leaf node serving as a root node comprises:
obtaining the encoding information corresponding to the second leaf node obtained by performing one-layer split on the first leaf node.

5. The method according to claim 1, wherein the method further comprises:
when the split instruction information of the first leaf node is used to instruct not to split the first leaf node, obtaining encoding information corresponding to the first leaf node, and generating, based on the encoding information corresponding to the first leaf node, a reconstructed image corresponding to the first leaf node.

6. The method according to claim 1, wherein the obtaining encoding information corresponding to a second leaf node obtained by splitting the first leaf node serving as a root node comprises:
obtaining the encoding information corresponding to the second leaf node obtained by performing at-least-two-layer split on the first leaf node.

7. The method according to claim 1, wherein the obtaining encoding information corresponding to a second leaf node obtained by splitting the first leaf node serving as a root node comprises:
obtaining split instruction information of a current node obtained by performing one-layer split on the first leaf node; and
when the split instruction information of the current node is used to instruct to split the current node, obtaining the encoding information corresponding to the second leaf node obtained by splitting the current node.

8. The method according to claim 7, wherein the obtaining split instruction information of a current node obtained by performing one-layer split on the first leaf node comprises:
when information about the current node meets a recursive split condition, obtaining the split instruction information of the current node obtained by performing one-layer split on the first leaf node.

9. The method according to claim 8, wherein the recursive split condition comprises at least one of the following conditions:
a recursive split level of the current node is less than a third preset threshold; and a side length of an image corresponding to the current node or a logarithm of the side length to base 2 is greater than a fourth preset threshold.

10. The method according to claim 1, wherein the method further comprises:
when the information about the first leaf node does not meet the split condition, obtaining encoding information corresponding to the first leaf node, and generating, based on the encoding information corresponding to the first leaf node, a reconstructed image corresponding to the first leaf node.

11. A video decoder, comprising:
at least one memory; and
at least one processor coupled to the at least one memory, wherein the at least one processor is configured to: obtain information about a first leaf node obtained by splitting a coding tree unit serving as a root node; when the information about the first leaf node meets a split condition, obtain split instruction information of the first leaf node; when the split instruction information of the first leaf node is used to instruct to split the first leaf node, obtain encoding information corresponding to a second leaf node obtained by splitting the first leaf node serving as a root node; and generate, based on the encoding information corresponding to the second leaf node, a reconstructed image corresponding to the second leaf node.

12. The video decoder according to claim 11, wherein the at least one processor is configured to:
obtain the encoding information corresponding to the second leaf node obtained by performing one-layer split on the first leaf node.

13. The video decoder according to claim 11, wherein the at least one processor is configured to:
when the split instruction information of the first leaf node is used to instruct not to split the first leaf node, obtain encoding information corresponding to the first leaf node; and generate, based on the encoding information corresponding to the first leaf node, a reconstructed image corresponding to the first leaf node.

14. The video decoder according to claim 12, wherein the at least one processor is configured to:
obtain the encoding information corresponding to the second leaf node obtained by performing at-least-two-layer split on the first leaf node.

15. The video decoder according to claim 14, wherein the at least one processor is configured to:
obtain split instruction information of a current node obtained by performing one-layer split on the first leaf node; and when the split instruction information of the current node is used to instruct to split the current node, obtain the encoding information corresponding to the second leaf node obtained by splitting the current node.

16. The video decoder according to claim 15, wherein the at least one processor is configured to:
when information about the current node meets a recursive split condition, obtain the split instruction information of the current node obtained by performing one-layer split on the first leaf node.

17. The video decoder according to claim 11, wherein the at least one processor is configured to:
when the information about the first leaf node does not meet the split condition, obtain encoding information corresponding to the first leaf node; and generate, based on the encoding information corresponding to the first leaf node, a reconstructed image corresponding to the first leaf node.
